(19) United States
(12) Patent Application Publication
(10) Pub. No.: US 2007/0020074 A1
(43) Pub. Date: Jan. 25, 2007

(54) Containerized transport and storage system

(76) Inventor: John Hansen, Belleair Beach, FL (US)

Correspondence Address: Arthur W. Fisher, III, Suite 316, 5553 West Waters Avenue, Tampa, FL, 33634, US

(21) Appl. No.: 11/188,490

(22) Filed: Jul. 25, 2005

(51) Int. Cl. B60P 1/64

(52) U.S. Cl. 414/498

(57) ABSTRACT

A containerized transport and storage system for use with a truck or other transport means to selectively store and transport goods or materials therein comprising a container configurable in a collapsed or disassembled configuration to move the container without goods or materials therein and an erected or assembled configuration to move the container with goods or materials therein and a plurality of container lift assemblies to selectively engage the container when in the erected or assembled configuration to selectively move the container vertically from a transport position on a truck or other transport means to a storage position on the ground or other support surface and from the storage position on the ground or other support surface to the transport position on a truck or other transport means.

### BACKGROUND OF THE INVENTION

### Field of the Invention

A containerized transport and storage system for use with a truck or other transport means to selectively store and transport goods or materials therein.

### SUMMARY OF THE INVENTION

The present invention relates to a containerized transport and storage system to selectively store and transport goods or materials therein comprising a container and a plurality of container lift assemblies. The container can be configured in an erected or assembled configuration for transportation and/or storage of goods or materials, and in a collapsed or dissembled configuration, for transportation and/or storage of the containerized transport and storage system itself.

The container comprises a pair of container side panels, a first and second container end panel, a container top and container base held in operative relationship relative to each other by a plurality of corner posts or members.

The container top comprises a container top frame including a pair of container top side frame members and a pair of container top end frame members to support a container top panel. A coupler or connector member extends downwardly from each corner portion of the container top frame to detachably secure corresponding corner posts or members and one of the container sides and the first container end or second container end thererto.

The container bottom comprises a container bottom frame including a pair of container bottom side frame members and a pair of container bottom end frame members to cooperatively form a rectilinear configuration to support a container bottom panel. A coupler or connector member extends upwardly from each corner portion of the container bottom frame to detachably secure corresponding corner posts or members and one of the container sides and either the first container end or second container end thereto.

The container lift assembly comprises a lower lift member supported on the ground or other surface telescopingly disposed within an upper lift member. The upper lift member is moved vertically by a positioning mechanism coupled to a positioning motor. A first lift coupler is held in fixed spaced relationship relative to the upper lift member by an interconnecting member. A second lift coupler is affixed to each corner post or member to selectively engage the first lift coupler of the corresponding container lift assembly to raise or lower a container.

The invention accordingly comprises the features of construction, combination of elements, and arrangement of parts which will be exemplified in the construction hereinafter set forth, and the scope of the invention will be indicated in the claims.

### BRIEF DESCRIPTION OF THE DRAWINGS

For a fuller understanding of the nature and object of the invention, reference should be had to the following detailed description taken in connection with the accompanying drawings in which:

FIG. 1 is a side view of a pair of erected or assembled containers of the present invention on a truck.

FIG. 2 is a side view of an erected or assembled container on a truck and the container lift system of the present invention.

FIG. 3 is a side view of an erected or assembled container of the present invention supported above the ground and truck bed by the container lift system.

FIG. 4 is a perspective view of an erected or assembled container of the present invention.

FIG. 5 is a top view of an erected or assembled container of the present invention.

FIG. 6 is a bottom view of an erected or assembled container of the present invention.

FIG. 7 is a side view of an erected or assembled container of the present invention.

FIG. 8 is a front view of an erected or assembled container of the present invention.

FIG. 9 is a rear view of an erected or assembled container of the present invention.

FIG. 10 is a side view of a collapsed or disassembled container of the present invention.

FIG. 11 is a rear view of a collapsed or disassembled container of the present invention.

FIG. 12 is a rear view of a collapsed or disassembled container of the present invention supported on casters.

FIG. 12A is a rear view of a collapsed or disassembled container of the present invention supported on rollers.

FIG. 13 is a side view of the top assembly of the present invention.

FIG. 14 is a rear view of the top assembly of the present invention.

FIG. 15 is a side view of the bottom assembly of the present invention.

FIG. 16 is a rear view of the bottom assembly of the present invention.

FIG. 17 is a perspective of a container lift assembly of the present invention.

FIG. 18 is a rear view of a plurality of stacked collapsed or disassembled containers of the present invention.

FIG. 19 is a top view of an erected or assembled container of the present invention with an alternative container lift assembly.

FIG. 20 is a side view of an erected or assembled container of the present invention with an alternative container lift assembly.

FIG. 21 is an end view of an erected or assembled container of the present invention with an alternative container lift assembly.

Similar reference characters refer to similar parts throughout the several views of the drawings.

### DETAILED DESCRIPTION OF THE INVENTION

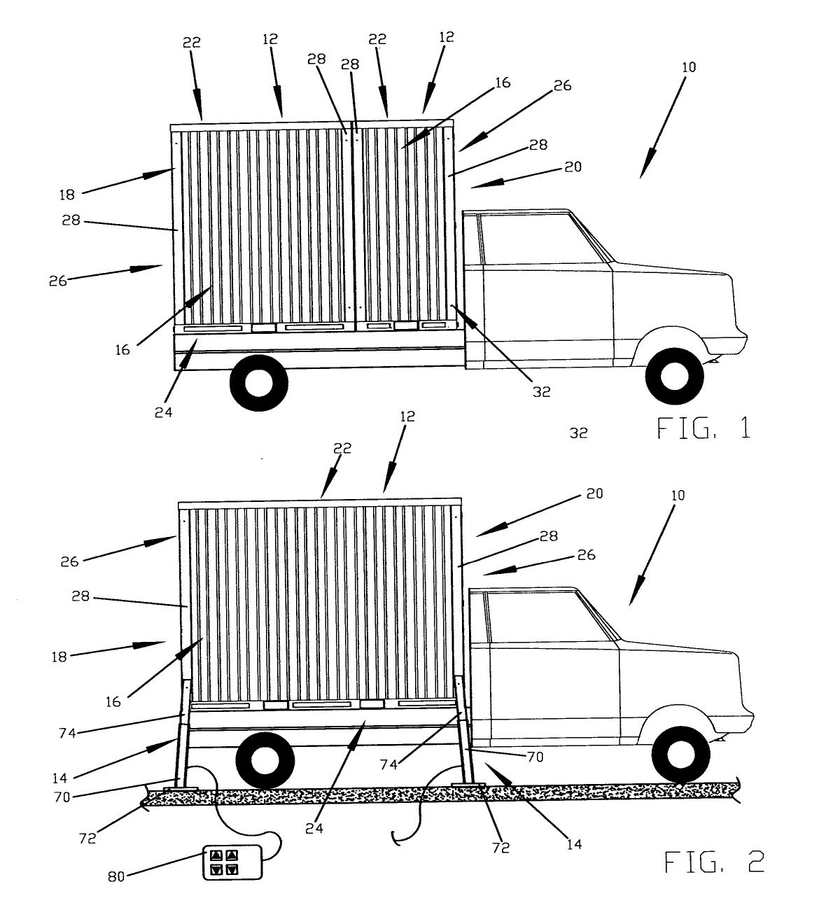

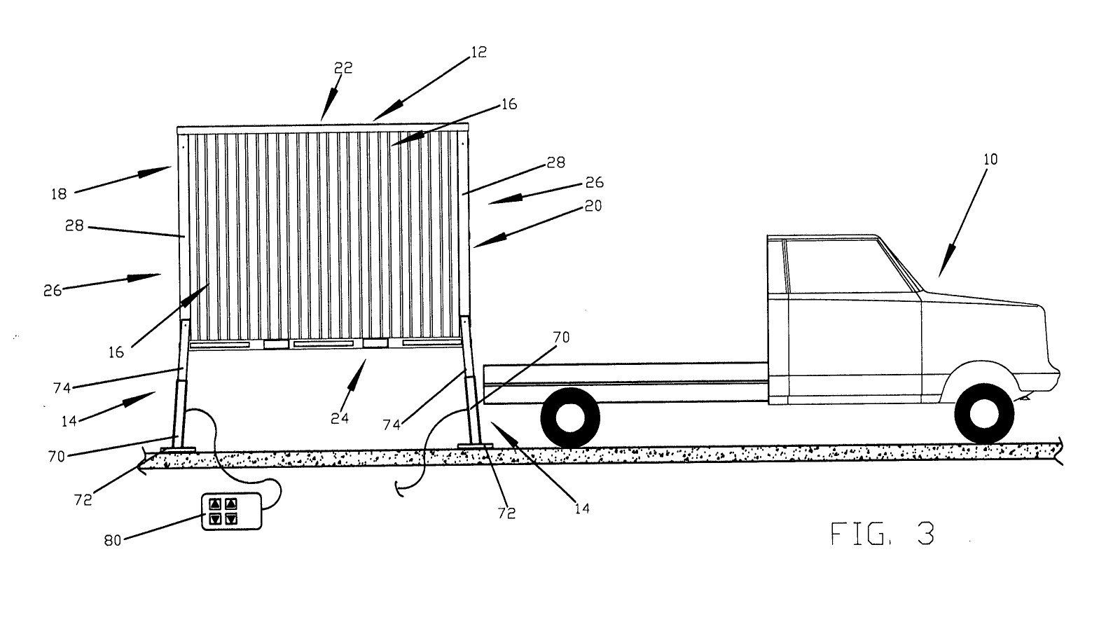

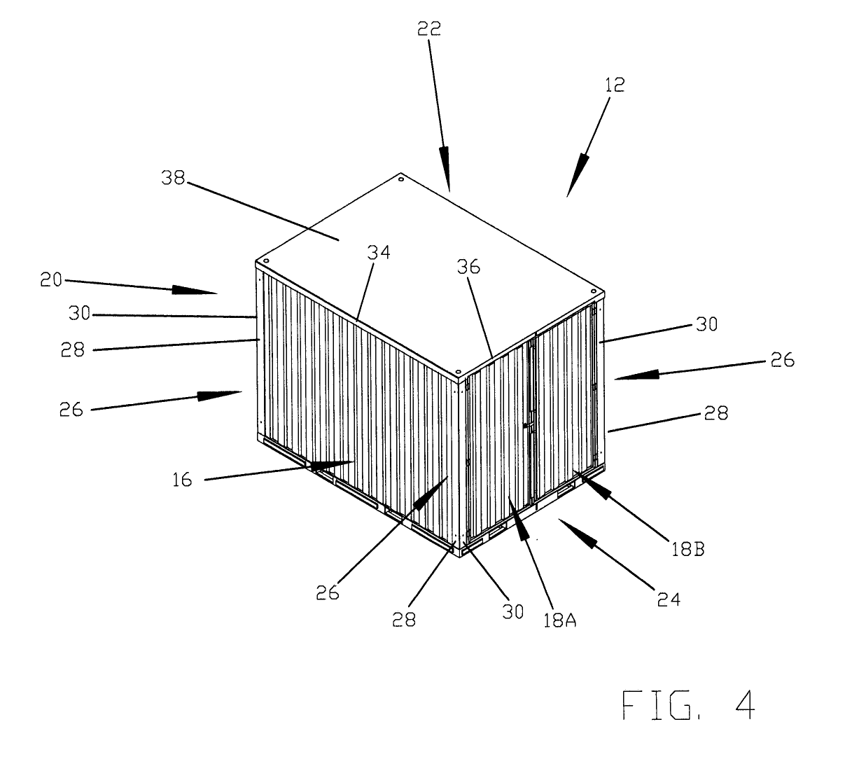

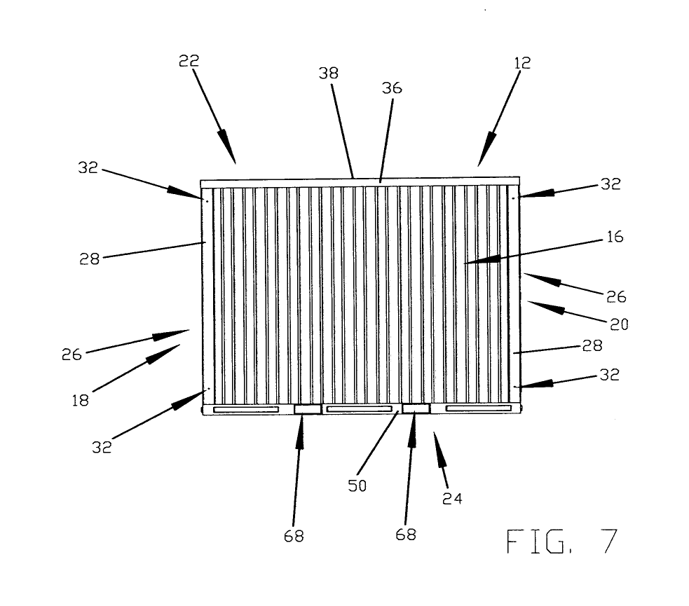

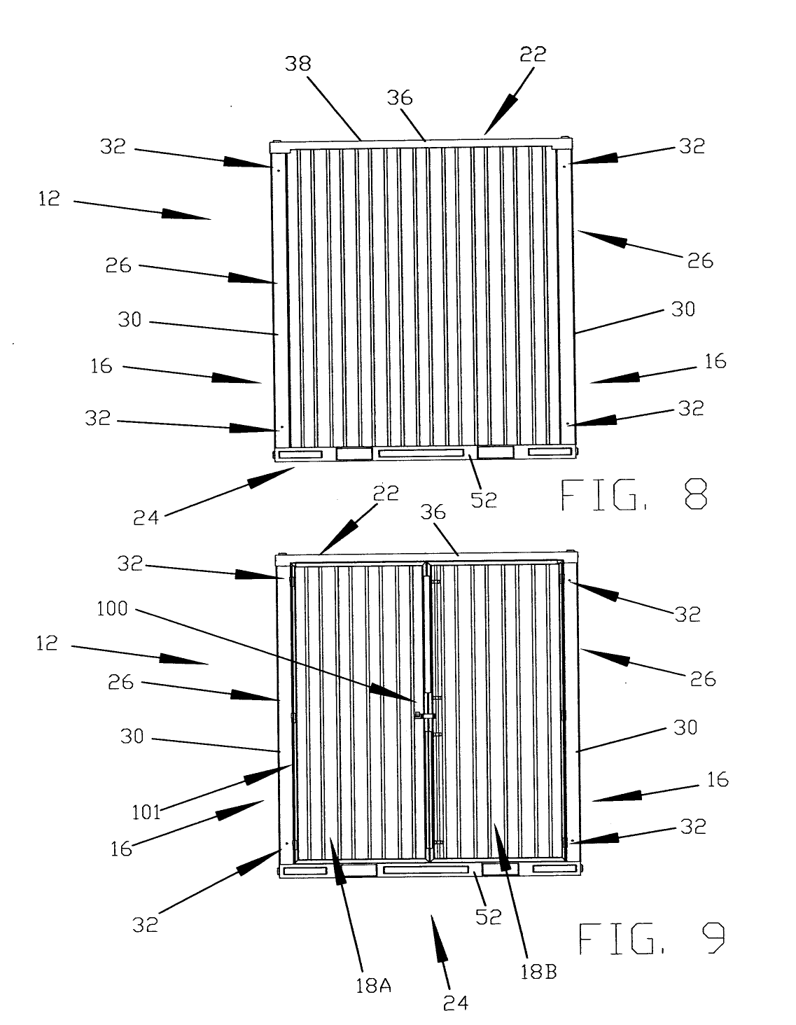

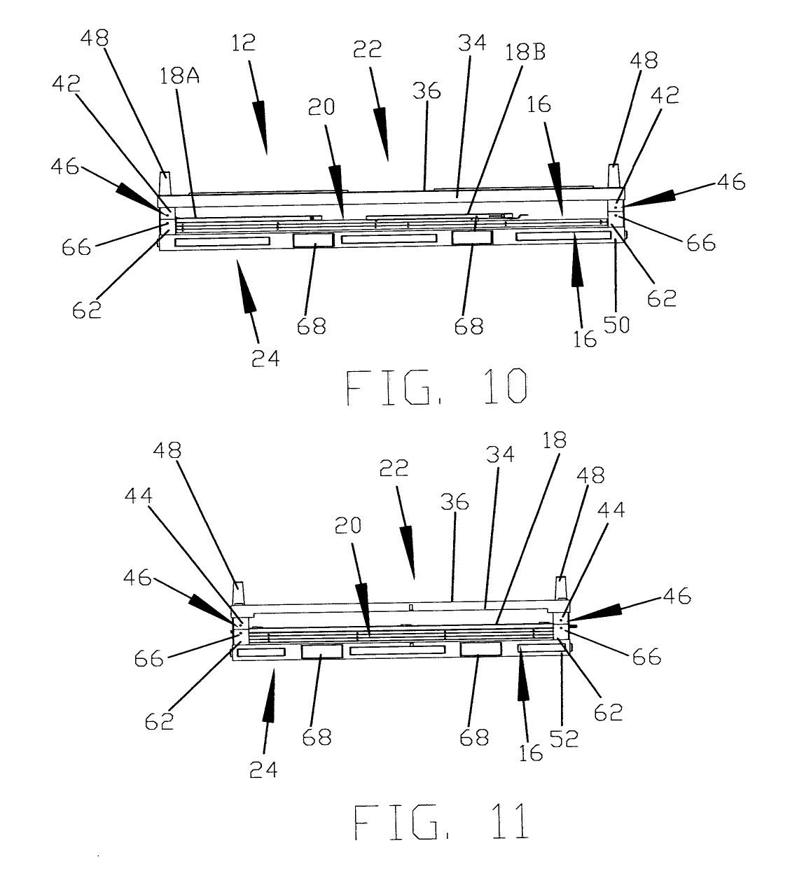

As shown in FIGS. 1 through 3, the present invention relates to a containerized transport and storage system for use with a truck generally indicated as 10 to selectively store and transport goods or materials therein. As shown in FIGS. 2 and 3, the containerized transport and storage system comprises a container generally indicated as 12 and a plurality of container lift assemblies each generally indicated as 14. The container 12 can be configured in an erected or assembled configuration for transportation and/or storage of goods or materials, FIGS. 4 and 7 through 9, and in a collapsed or disassembled configuration, for transportation and/or storage of the containerized transport and storage system itself, FIGS. 10 through 12.

The container 12 of the present invention comprises a pair of a container side panels each generally indicated as 16, a first and second container end panel generally indicated as 18 and 20 respectively, and a container top and container base indicated generally as 22 and 24 respectively held in operative relationship relative to each other by a plurality of corner posts or members each generally indicated as 26 including a first and second element or leg 28 and 30 respectively, disposed as substantially right angles to each other, when in the erected or assembled configuration. Apertures 32 are formed through the upper and lower portions of the first and second elements or legs 28 and 30 of the corresponding corner post or member 26 to receive fasteners therethrough to selectively maintain the container 12 in the erect or assembled configuration.

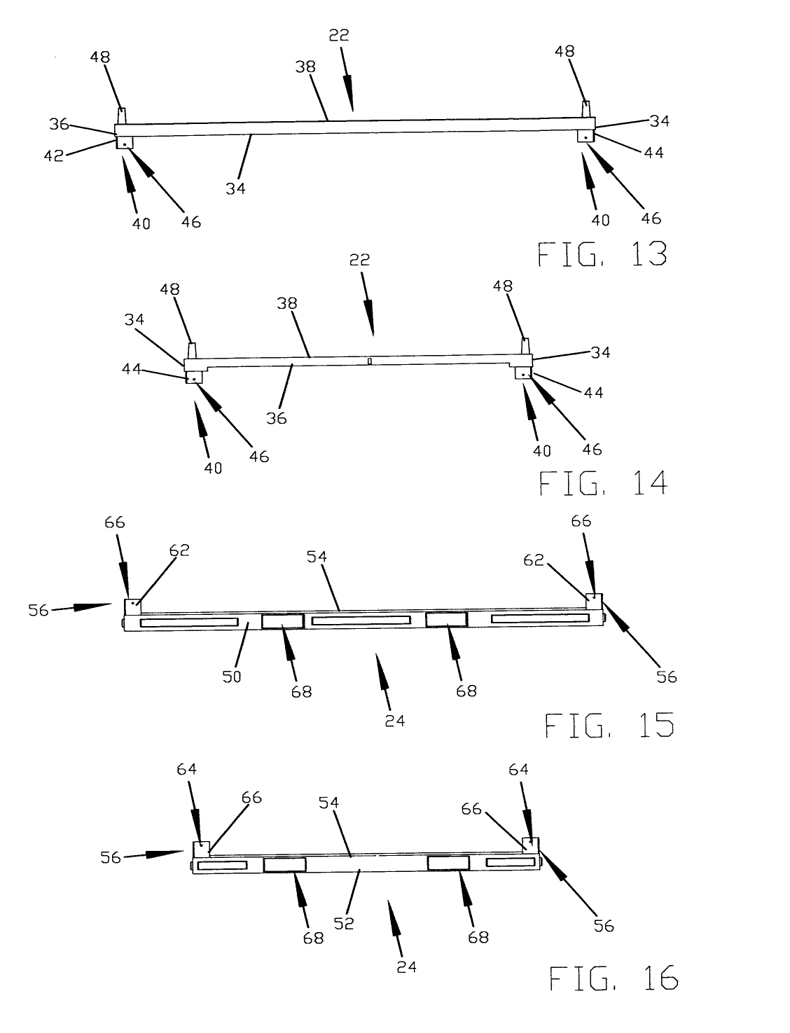

As best shown in FIGS. 13 and 14, the container top 22 comprises a container top frame including a pair of container top side frame members each indicated as 34 and a pair of container top end frame members each indicated as 36 to cooperatively form a rectilinear configuration to support a container top panel 36 thereon. A coupler or connector member generally indicated as 40 extends dowardly from each corner portion of the container top frame to detachably secure corresponding corner posts or members 26 and a portion of one of the container sides 16 and the first container end 18 or second container end 20 thereto.

Each coupler or connector member 40 comprises a first and second connector element or leg indicated as 42 and 44 respectively to cooperatively form an intersection to receive an end portion of adjacent container panels 16 and 18 or 20 as described more fully hereinafter. Both the first and second connector elements or legs 42 and 44 include an aperture 46 formed therein to receive a fastener extending through a corresponding aperture 32 formed through the upper portion of the corresponding first or second connector element leg 28 or 30 of the corresponding corner post or member 26 as described more fully hereinafter. A container stacking post 48 comprising a tapered member extends upwardly from each corner portion of the container top panel 38 of the container top 22.

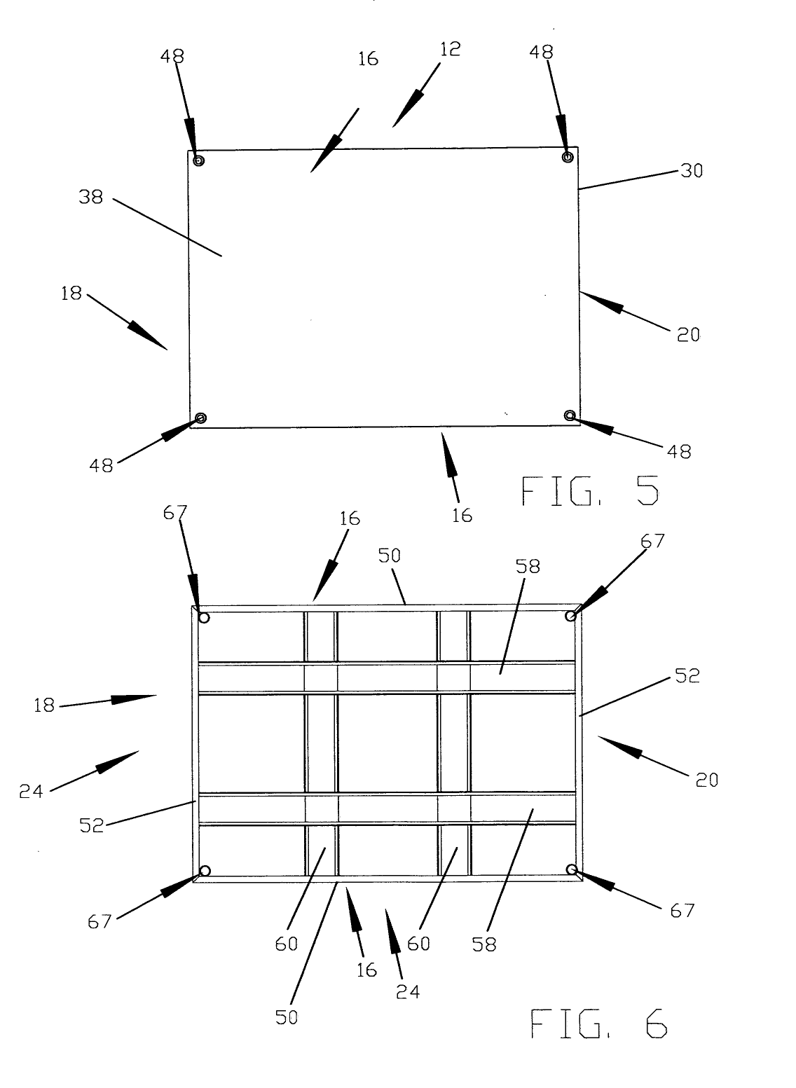

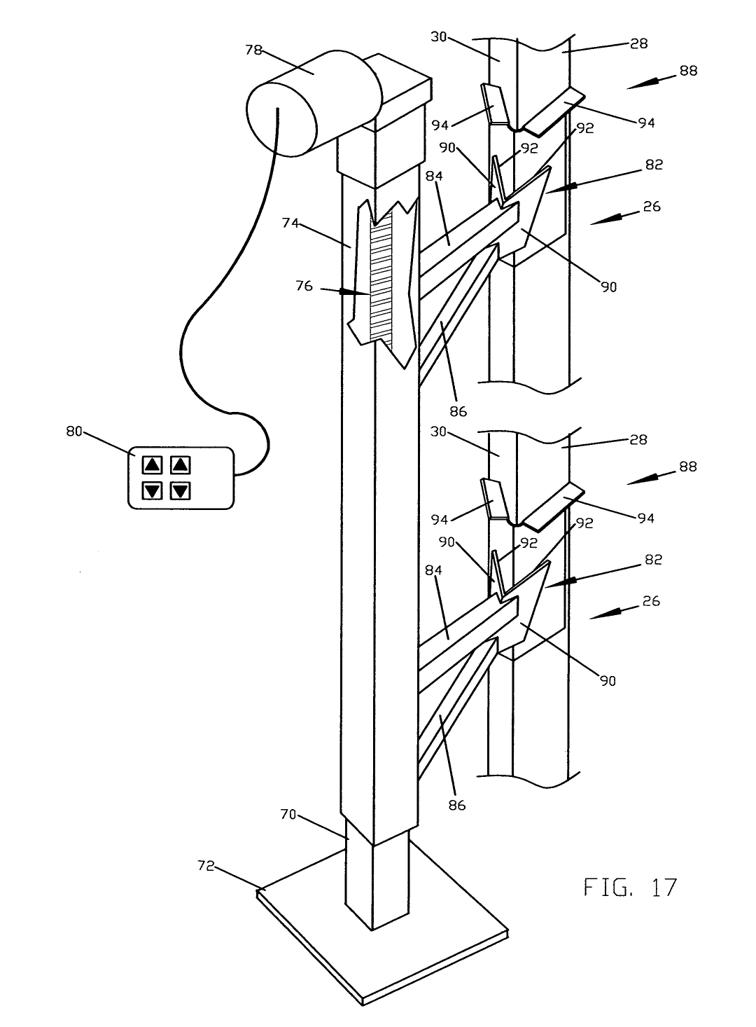

As best shown in FIGS. 15 and 16, the container bottom 24 comprises a container bottom frame including a pair of container bottom side frame members each indicated as 50 and a pair of container bottom end frame members each indicated as 52 to cooperatively from a rectilinear configuration to support a container bottom panel 54 thereon. A coupler or connector member generally indicated as 56 extends upwardly from each corner portion of the container bottom frame to detachably secure corresponding corner posts or members 26 and one of the container sides 16 and either the first container end 18 or second container end 20 thereto. As shown in FIG. 6, the container bottom frame further includes a plurality of longitudinal frame members each indicated as 58 and a plurality of transverse frame members each indicated as 60.

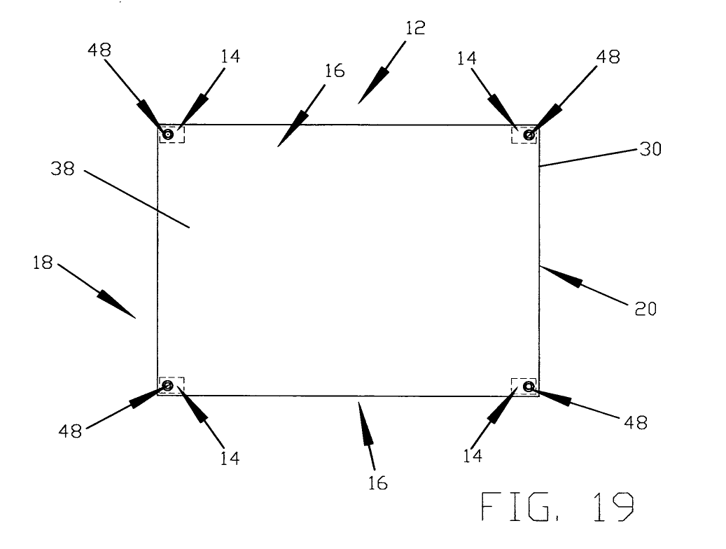

Each coupler or connector member 56 comprises a first and second connector element or leg indicated as 62 and 64 respectively to cooperatively from an intersection to receive an end portion of adjacent container panels 16 and 18 or 20 as described more fully hereinafter. Both the first and second connector elements or legs 62 and 64 include an aperture 66 formed therein to receive a fastener extending through a corresponding aperture 32 formed through the lever portion of the corresponding first or second connector element or leg 28 or 30 of the corresponding corner post or member 26 as described more fully hereinafter. A container stacking aperture 67 is formed through each corner portion of the container bottom panel 54 of the container base 24 to receive the corresponding container stacking post 48 when collapsed or disassembled containers 12 are stacked as shown in FIG. 18.

Each container bottom side frame member 50 and each container bottom end frame member 52 includes a pair of spaced apart openings each indicated as 68 to receive a portion of and accommodate a fork lift or other lifting device.

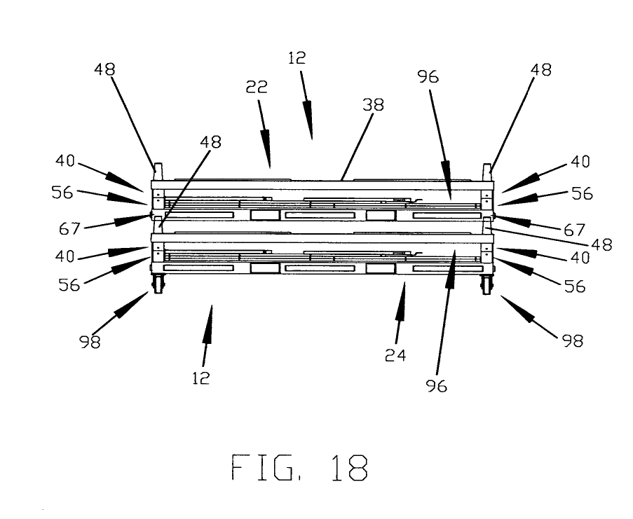

The structure of a container lift assembly 14 is best shown in FIG. 17. Specifically, the container lift assembly 14 comprises a lower lift member 70 supported on the ground or other surface by a lift base 72 disposed around an upper lift member 74. The upper lift member 74 is moved telescopingly or vertically with the lower lift member 70 by a positioning mechanism 76 such as a gear arrangement or hydraulic piston/cylinder combination coupled to a positioning motor or actuator 78 controlled remotely by a lift control 80. A first lift coupler generally indicated as 82 is held in fixed spaced relationship relative to the upper lift member 74 by a first and second interconnecting member 84 and 86 respectively. A second lift coupler generally indicated as 88 is affixed to each corner post or member 26 to selectively engage the first lift coupler 82 of the corresponding container lift assembly 14 to raise or lower a container 12 as described more fully hereinafter.

The first lift coupler 82 comprises a pair of first coupler plates each indicated as 90 disposed at about 88 degrees relative to each other to engage the intersection of the first and second elements or legs 28 and 30 when the first coupler plates 90 engage the first and second elements or legs 28 and 30 of the corresponding corner post or member 26. The upper edges 92 of each first coupler plate 90 are inclined upwardly at an angle of at least about 30 degrees and preferably from about 40 degrees to about 44 degrees. The second lift coupler 88 comprises a pair of second coupler plates each indicated as 94 extending outwardly from the corresponding first and second leg or element 28 and 30 of each corner post or member 26 at an angle of less than about 45 degrees. Each second coupler plate 94 is inclined upwardly at an angle of about at least 45 degrees such that the upper edges 92 of each first coupler plate 90 engages the corresponding second coupler plate 94 and the corresponding first and second element or leg 28 and 30 to detachably couple each container lift assembly 14 to the corresponding corner post or member 26.

As shown in FIG. 17, a pair of first lift couplers 82 and a corresponding pair of second lift couplers 88 may be used.

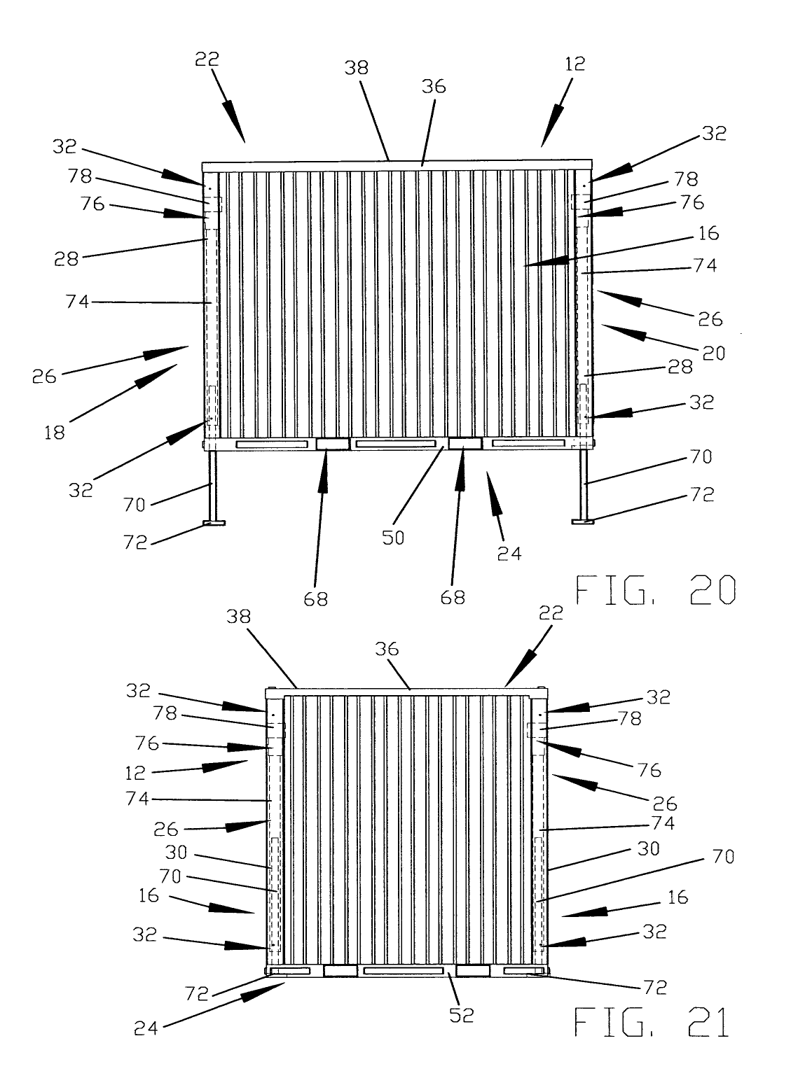

Alternatively, as shown in FIGS. 19 through 21, each container lift assembly 14 may be disposed internally within the container 12 at each of the 4 corners thereof. Specifically, each container lift assembly 14 comprises a lower lift member 70 supported on the ground or other surface by a lift base 72 disposed within upper lift member 74 attached to the container 14. The lower lift member 72 is moved telescopingly or vertically within the upper lift member 74 by a positioning mechanism 76 such as a gear arrangement or hydraulic piston/cylinder combination coupled to a positioning motor or actuator 78 controlled remotely by a lift control 80.

As shown in FIG. 18, a plurality of collapsed or disassembled containers 12 may be stacked one upon another. When dissembled for storage or transport without goods or materials, each coupler or connector member 40 of the container top 22 engages the corresponding coupler or connector member 56 of corresponding container base 24 to cooperatively form a storage space 96 for the corresponding container side panels 16, first container end panel 18 and second container end panel 20. When the containers 12 are stacked, each of the container stacking posts 48 extending upwardly form the corresponding container top panel 30 of the container top 22 extends through the corresponding container stacking aperture 67 formed in the corresponding container bottom panel 54 of the container base 24.

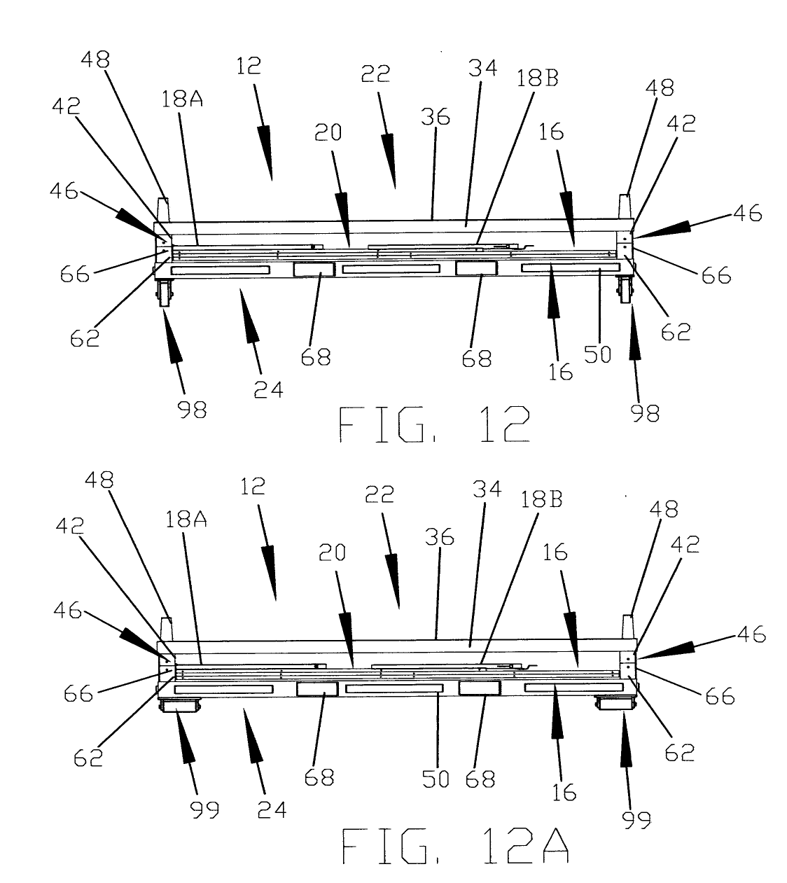

As shown in FIGS. 12 and 18, the containers 12 may be supported by a plurality of casters each indicated as 98. Alternatively, as shown in FIG. 12A, the containers 12 may be supported by a plurality of rollers each indicated as 99.

As shown in FIGS. 9 through 11, the first container end panel 18 may comprise a pair of panel sections indicated as 18A and 18B hingedly attached to a corresponding corner post or member 26 by a hinge generally indicated as 101. The end panel sections 18A and 18B can be securely closed by a lock mechanism generally indicated as 100.

To erect the container, side panels 16, first and second container end panels 18 and 20, container top 22 and container base 24, and corner posts or members 26 are assembled. Fasteners are extended through apertures 32 formed in the upper and lower portions of the first and second elements or legs 28 and 30, corresponding apertures (not shown) formed through the container side panels 16, first and second end panels 18 (18A and 18B) and then through apertures 46 formed in the corresponding first and second connector element or leg 42 and 44 of the corresponding coupler or connector member 40 of the container top 22 and through apertures 66 formed in the corresponding first and second connector element or leg 62 and 64 of the corresponding coupler or connector member 56 of the container base 24.

To load the container 12 onto the truck 10, a container lift assembly 14 is positioned at each of the four corners of an erected or assembled container 12 such that the first coupler plate 90 engages the first and second elements or legs 28 and 30 of the corresponding corner post or member 26 and the corresponding second coupler plates 94. The positioning motors or actuators 78 are activated or energized by the lift control 80 to move the corresponding upper lift member 74 upward raising the container base 24 to a height above the truck bed allowing the truck 10 to be positioned under the container 12. The positioning motor or actuator 78 is reversed lowering the container 12 onto the truck bed for transport.

The container 12 is removed from the truck bed by a similar process.

The alternate embodiment of the container lift assemblies 14 operate in a similar manner to vertically position the container 12.

It will thus be seen that the objects set forth above, among those made apparent from the preceding description are efficiently attained and since certain changes may be made in the above construction without departing from the scope of the invention, it is intended that all matter contained in the above description or shown in the accompanying drawing shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

Now that the invention has been described,

What is claimed is:

1. A containerized transport and storage system for use with a truck or other transport means to selectively store and transport goods or materials therein comprising a container configurable in a collapsed or disassembled configuration to move the container without goods or materials therein and an erected or assembled configuration to move the container with goods or materials therein and a plurality of container lift assemblies to engage the container when in the erected or assembled configuration to selectively move the container vertically from a transport position on a truck or other transport means to a storage position on the ground or other support surface and from the storage position on the ground or other support surface to the transport position on a truck or other transport means.

2. The containerized transport and storage system of claim 1 wherein said container comprises a pair of container side panels, a first and second container end panel, a container top and container base held in operative relationship relative to each other by a plurality of corner posts.

3. The containerized transport and storage system of claim 2 wherein said container top comprises a container top frame including a pair of container top side frame members and a pair of container top end frame members to support a container top panel and said container bottom comprises a container bottom frame including a pair of container bottom side frame members and a pair of container bottom end frame members to support a container bottom panel.

4. The containerized transport and storage system of claim 3 wherein a connector member extends downwardly from each corner portion of said container top frame to detachably secure said corner posts to corresponding container sides, said first container end or second container end and a connector member extends upwardly from each corner portion of said container bottom frame to detachably secure said corner posts to corresponding container sides, first container end or second container end.

5. The containerized transport and storage system of claim 4 wherein each said connector member comprises a first and second connector element to cooperatively form an intersection to receive an end portion of adjacent container panels.

6. The containerized transport and storage system of claim 2 wherein each said container lift assembly comprises a lower lift member supported on the ground or other surface telescopingly disposed within an upper lift member, upper lift member vertically movable by a positioning mechanism.

7. The container transport and storage system of claim 6 wherein said positioning mechanism operatively engages a positioning motor.

8. The containerized transport and storage system of claim 6 further including a first lift coupler held in fixed spaced relationship relative to a corresponding upper lift member by an interconnecting member and a second lift coupler affixed to a corresponding corner post to selectively engage said first lift coupler of the corresponding container lift assembly to raise or lower a container.

9. The containerized transport and storage system of claim 8 wherein said first lift coupler comprises a pair of first coupler plates to engage the intersection of said first and second connector elements when said first coupler plates engages said first and second connector elements of corresponding corner post and said second lift coupler comprises a pair of second coupler plates extending outwardly from corresponding first and second connector element of each corner post.

10. The containerized transport and storage system of claim 9 wherein said first coupler plates are disposed at about 88 degrees relative to each other.

11. The containerized transport and storage system of claim 10 wherein the upper edges of each first coupler plate are inclined upwardly at an angle of less than about 45 degrees.

12. The containerized transport and storage system of claim 11 wherein each second coupler plate is inclined upwardly at an angle of at least about 45 degrees such that the upper edges of each first coupler plate engages corresponding second coupler plate and corresponding first and second element to detachably couple each said container lift assembly to the corresponding corner post.

13. The containerized transport and storage system of claim 9 wherein the upper edges of each first coupler plate are inclined upwardly at an angle of less than about 45 degrees.

14. The containerized transport and storage system of claim 13 wherein each second coupler plate is inclined upwardly at an angle of at least about 45 degrees such that the upper edges of each first coupler plate engages corresponding second coupler plate and corresponding first and second element to detachably couple each said container lift assembly to the corresponding corner post.

15. The containerized transport and storage system of claim 3 wherein a container stacking aperture is formed through each corner portion of the container bottom panel of said container base to receive the corresponding container stacking post when collapsed or disassembled container are stacked.

16. The containerized transport and storage system of claim 3 wherein each container bottom side frame member and each container bottom end frame member includes a pair of spaced apart openings to receive a portion of and accommodate a fork lift or other lifting device.

17. The containerized transport and storage system of claim 2 wherein said plurality of container lift assemblies comprise a container lift assembly disposed within a corresponding corner post.

18. The containerized transport and storage system of claim 17 wherein each said container lift assembly comprises a base lift member and an upper lift member disposed in telescopingly relationship relative to each other and a positioning mechanism is selectively move the container vertically.

19. The container transport and storage system of claim 18 wherein said positioning mechanism operatively engages a positioning motor.
